(19) United States
(12) Patent Application Publication
(10) Pub. No.: US 2011/0171429 A1
(43) Pub. Date: Jul. 14, 2011

(54) LOW GLOSS SURFACE DECORATIVE FILM AND DECORATED ARTICLE FORMED THEREWITH

(76) Inventors: Ming-Hung HUANG, Kaohsiung City (TW); Chao-Peng Tseng, Taoyuan County (TW); Chih-Yuan Liao, Hsinchu County (TW)

(21) Appl. No.: 12/686,218

(22) Filed: Jan. 12, 2010

(51) Int. Cl. B32B 7/06; B44C 1/165; B32B 3/18

(52) U.S. Cl. 428/162; 428/161

(57) ABSTRACT

The present invention discloses a low gloss surface decorative film comprising a dulling layer and a releasing layer. The dulling layer has a plurality of dulling particles secured therein and has a dulling surface on one side thereof. The dulling particles are distributed in the dulling layer and make the dulling surface have a plurality of protrusions and recessions. The releasing layer is formed on the dulling surface of the dulling layer and adheres to a hard layer or an ink layer. The hard layer has a first protrusion-recession surface complementary to the dulling surface.

### FIELD OF THE INVENTION

The present invention relates to a decorative film, particularly to a low gloss surface decorative film.

### BACKGROUND OF THE INVENTION

With the tendency of compactness and miniaturization, the portable electronic products, such as notebook computers, personal digital assistants and mobile phones, have been the indispensable equipment or accessories carried about by people. Beside the functions, the appearance of a product is also an important factor determining whether a customer buys it.

Traditionally, the drawing or decoration on the plastic casing of a product is usually formed via printing or coating various patterns and colors on the casing. During a coating process, various shield coatings and shield films must be applied to form working regions, and the paints are sprayed sequentially, which is a complicated and time-consuming process and unfavorable to mass production. A coating process usually generates a great amount of mist containing lead or other heavy metals, which not only wastes paint but also pollutes the environment. Besides, the hard coating or anti-abrasion coating is uneasy to have a uniform thickness, especially on a curved surface.

To solve the abovementioned problems, the related manufacturer developed an IMR (In Mold Roller) technology. Firstly, a decorative film containing a hard layer is placed in an injection mold. Molten resin is fed into the injection mold with an injection-molding method. Then, the resin and the decorative film are fused together to form a resin workpiece. After a support film having a releasing agent is stripped off from the resin workpiece to reveal the hard layer, the IMR process is completed. The revealed hard layer is usually a smooth surface having appropriate gloss. When the fingers contact the surface of the hard layer, the grease of the skin easily adheres to the hard layer, and the fingerprints are thus printed on the smooth hard surface, which should affect the appearance of the product. On the other hand, the conventional IMR process may be hard to express a low gloss surface.

Recently, several transfer-printing technologies were developed to form a dull surface, such as Japan patents of Kokai No. 2001-30405, Kokai No. 2001-179922 and Kokai No. 2005-36168, which can forms a low gloss surface decorative film, wherein dulling particles are added into the hard layer to scatter light and roughen the surface. However, the dulling particles are likely to deposit and spread unevenly. In some cases, dulling particles are added into the releasing layer of the decorative film. However, the releasing layer usually has silicone material that is poorly compatible with the dulling particles, and thereby organic phases are likely to segregate from inorganic phases in the dried film, which also causes the uneven distribution of the dulling particles.

### SUMMARY OF THE INVENTION

One embodiment of the present invention provides a low gloss surface decorative film, which comprises a dulling layer and a releasing layer. The dulling layer contains a plurality of dulling particles secured therein. One side of the dulling layer is a dulling surface having a plurality of protrusions and recessions formed by the dulling particles. The releasing layer is arranged on the dulling surface and adheres to a hard layer or an ink layer. The hard layer has a first protrusion-recession surface corresponding to the protrusions and recessions of the dulling surface.

In another embodiment of the present invention, a support layer is arranged on one surface of the dulling layer, which is opposite to the dulling surface. The dulling layer is formed on the support layer via an intaglio process. The intaglio process may be a roller-printing process or an imprint process. An ink layer containing patterns or text is formed on one surface of the hard layer, which is opposite to the first protrusion-recession surface. An adhesion layer is formed on one surface of the ink layer and adheres to a workpiece. The ink layer is made of a sublime transfer-printing ink, a heat fusion transfer-printing ink, or a UV transfer-printing ink. The adhesion layer is made of a hot-melt glue, a UV glue, a light-activated glue, or an e-beam-activated glue.

### BRIEF DESCRIPTION OF THE DRAWINGS

FIG. 1 is a sectional view schematically showing a low gloss surface decorative film according to one embodiment of the present invention;

FIG. 2 is a sectional view schematically showing that a releasing layer is separated from a hard layer according to one embodiment of the present invention;

FIG. 3 is a sectional view schematically showing the partially dulled structure of a low gloss surface decorative film according to one embodiment of the present invention;

FIG. 4 is a sectional view schematically showing a dulling layer having different thicknesses according to one embodiment of the present invention;

FIG. 5 is a sectional view schematically showing a low gloss surface decorative film without a hard layer according to one embodiment of the present invention;

FIG. 6 is a sectional view schematically showing that a dulling layer is separated from a releasing layer in a hard-layer-free low gloss surface decorative film according to one embodiment of the present invention; and

FIG. 7 is a sectional view schematically showing that a dulling layer having different thicknesses in a hard-layer-free low gloss surface decorative film according to one embodiment of the present invention.

### DETAILED DESCRIPTION OF THE PREFERRED EMBODIMENTS

The embodiments of the present invention provide a low gloss surface decorative film and a decorated article form therewith. Below, the embodiments are described in detail in cooperation with the drawings.

In the specification and drawings of the present invention, the same reference numerals designate as the same elements. For clarity and convenience of description, some elements are not drawn according to the exact proportion. The elements and the assembly thereof are described below. However, the present invention does not limit the elements to be those depicted in the specification or drawings but also includes all forms of the elements obvious to the persons skilled in the art. In the specification, when a first layer is referred to being formed or arranged “over” a second layer, it may be the case that the first layer is directly arranged on the second layer, or the case that the first layer is indirectly arranged above the second layer with a third layer interposed between the first layer and the second layer.

Below, the technical contents of the present invention are described in accompany with the drawings.

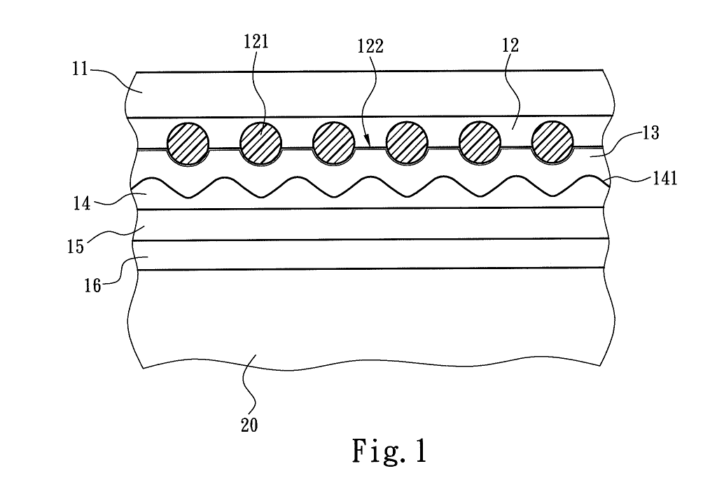

Refer to FIG. 1 a sectional view of a low gloss surface decorative film according to one embodiment of the present invention. The present invention provides a low gloss surface decorative film, which can apply to an IMR process, wherein the IMR process can transfer-print patterns or text to the surface of a workpiece 20. In one embodiment, examples of the material of the workpiece 20 useful herein include polycarbonate, acrylonitrile butadiene styrene, polymethylmethacrylate, polyoxymethylene, polybutylene terephthalate, polypropylene, MMA-St, polystyrene, or polyethylene terephthalate, but not limited thereto.

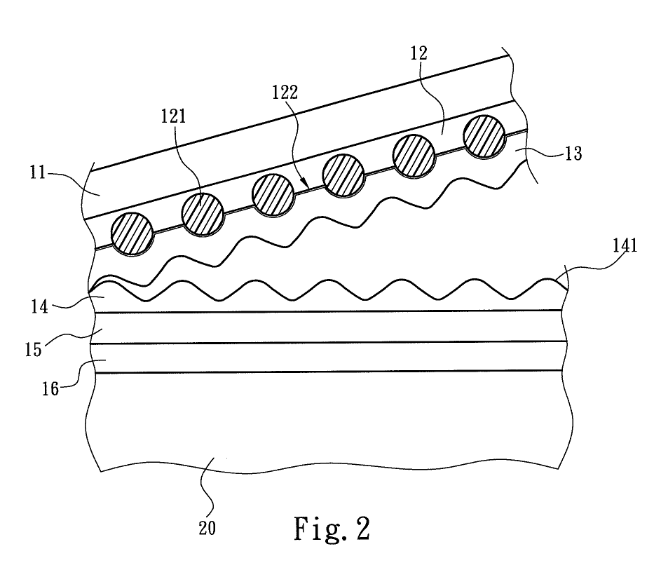

In the embodiment, the low gloss surface decorative film is transfer-printed onto the workpiece 20. The low gloss surface decorative film comprises a plurality of layers, including a dulling layer 12, an optional hard layer 14 and a releasing layer 13. The dulling layer 12 further comprises a plurality of dulling particles 121 and a dulling surface 122 having a plurality of protrusions and recessions formed by the dulling particles 121. The dulling layer 12 has a thickness of 1-30 μm. The optional hard layer 14 may be formed over one side of the dulling surface 122 via a printing or coating method. The surface of the optional hard layer 14 has a first protrusion-recession surface 141 corresponding to the protrusions and recessions of the dulling surface 122. A releasing layer 13 is formed between the dulling layer 12 and the hard layer 14 with a printing or coating method so that the dulling layer 12 can be easily separated from the hard layer 14. The dulling layer 12 together with the releasing layer 13 will be separated from the hard layer 14 by a stripping force, as shown in FIG. 2.

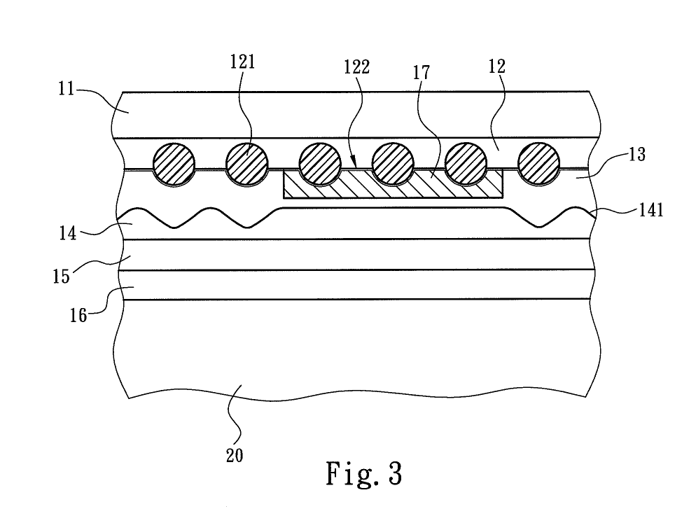

If the hard layer 14 is intended to be only partially dulled, a shield layer 17 is formed on a portion of the dulling surface 122 of the dulling layer 12 with an intaglio process or a screen process, as shown in FIG. 3. Thereby, the hard layer 14 has substantially flat surfaces corresponding to the shield layer 17 to be dulled partially. The shield layer 17 may be made of polyurethane, polymethylmethacrylate, epoxide, or polyester.

In one embodiment, examples of the materials of the dulling layer 12 may include polyurethane, polymethylmethacrylate, epoxide, or polyester. The dulling particles 121 may be made of silicon dioxide, calcium carbonate, calcium sulfate, barium sulfate, aluminum oxide, titanium oxide, a metal powder, an organic pigment, or an inorganic pigment. The dulling particles 121 may be in form of hollow spheres, non-film-forming latexes or dispersions. The dulling particles 121 have a diameter of 0.1 μm-30 μm. In one embodiment, the diameter of the dulling particles 121 is between 1 μm and 15 μm. The structure of the protrusions and recessions of the dulling layer 12 influences the ruggedness of the first protrusion-recession surface 141. However, the ruggedness of the dulling layer 12 is indirectly transferred to the first protrusion-recession surface 141 via the releasing layer 13. Therefore, the thickness of the releasing layer 13 influences the ruggedness of the first protrusion-recession surface 141. In the embodiment, the releasing layer 13 has a thickness of 1 μm-10 μm.

For IMR application, one surface of the dulling layer 12, which is opposite to the dulling surface 122, is placed on a support layer 11. The dulling layer 12 may be formed on the support layer 11 with an intaglio process or a coating process. The intaglio process may be a roller-printing process or an imprint process. Example of the material of the support layer 11 may be made of a polymeric material including polyethylene terephthalate, polyethylene naphthalate, polyethylene glycol-co-cyclohexane-1,4 dimethanol terephthalate, thermalplastic polyurethane, polyurethane, polypropylene, polycarbonate, amorphous polyethylene terephthalate, polyvinyl chloride, triacetyl cellulose, polymethylmethacrylate, MMA-St, cyclo olefin copolymer, or the combination of the abovementioned materials.

The materials applied in the hard layer 14 may include a radiation-cured multi-functional group acrylic ester, epoxide, a vinyl ester resin, diallyo(o-)phthalate, vinyl ether, or the combination of the abovementioned materials. The radiation-cured multi-functional group acrylic ester may be epoxy acrylate, polyurethane acrylate, polyester acrylate, silicone acrylate, or glycidyl acrylate. As the hard layer 14 is made of a thermosetting resin, the cured resin of the hard layer 14 has a surface structure corresponding to the structure of the surface where the hard layer 14 is placed. The dulling particles 121 are added to the dulling layer 12 to form the rugged dulling surface 122. Thus, the releasing layer 13 and the hard layer 14 above the dulling layer 12 also have rugged surfaces. In one embodiment, an ink layer 15 containing patterns or text is formed on one surface of the hard layer 14, which is opposite to the first protrusion-recession surface 141. The ink layer 15 may be made of a sublime transfer-printing ink, a heat fusion transfer-printing ink, or a UV (ultraviolet ray) transfer-printing ink. Besides, an adhesion layer 16 may be formed on the other side of the ink layer 15, which sticks to the workpiece 20. The adhesion layer 16 may be made of a hot-melt glue, a UV glue, a light-activated glue, or an e-beam-activated glue.

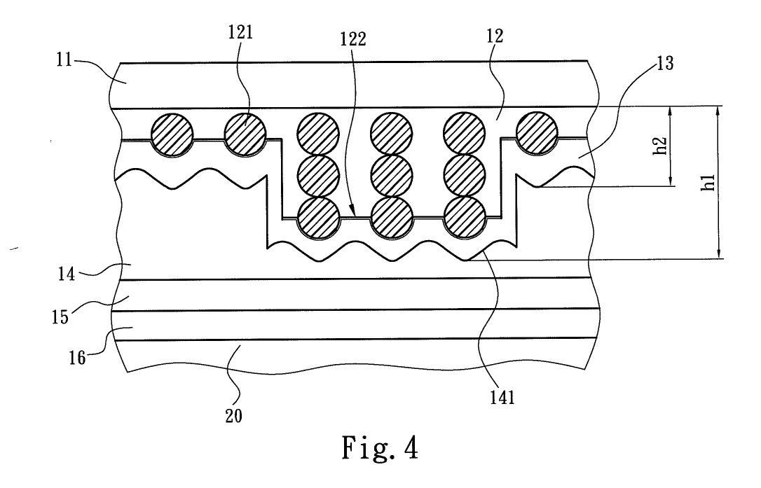

The dulling layer 12 may have a uniform thickness as described in the above embodiments or have at least two different thicknesses at different regions of the same plane. Refer to FIG. 4 a sectional view schematically showing a low gloss surface decorative film containing a dulling layer with two different thicknesses according to one embodiment of the present invention. In this embodiment, the dulling layer 12 has a relatively thinner first portion h1 and a relatively thicker second portion h2. The different thicknesses of the dulling layer 12 make the first protrusion-recession surface 141 have different depths correspondingly. Thus, the surface of the hard layer 14 can provide a wavelength shift of light in different directions and lead to an expression of a gradient gloss. The dulling layer 12 having the first portion h1 and the second portion h2 can be realized via using a plate-type or roller-type mold having different patterns to print the patterns on the support layer 11 in an intaglio process. Alternatively, a gravure having at least two different depths is used to print the dulling layer 12 having different thicknesses on the support layer 11. Corresponding to the dulling layer 12, the releasing layer 13 and the optional hard layer 14 that are formed over the dulling layer 12 have different-thickness areas, which generate a gradient gloss.

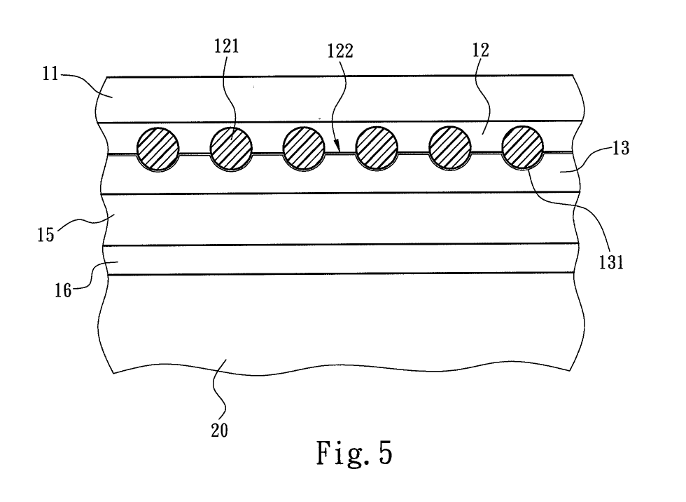

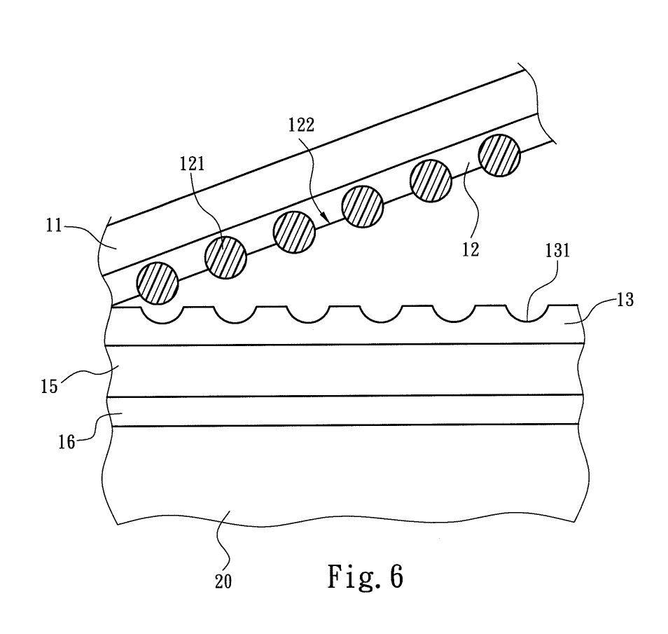

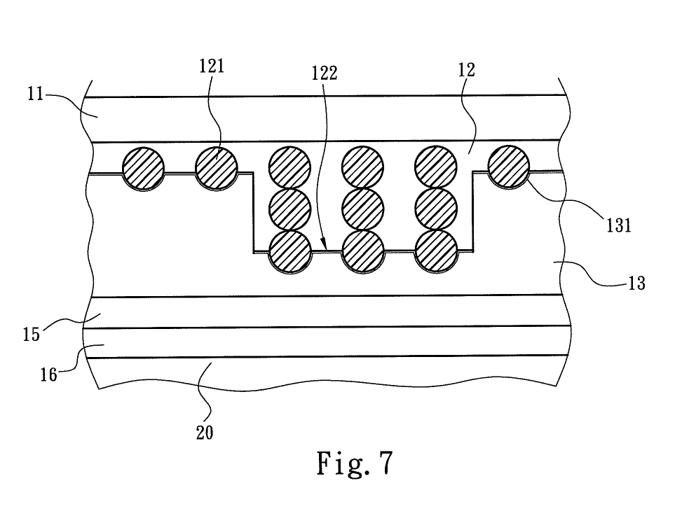

Refer to FIG. 5 a sectional view schematically showing a low gloss surface decorative film without a hard layer according to another embodiment of the present invention. The present invention also provides a low gloss surface decorative film without a hard layer, wherein the releasing layer 13 is directly arranged on the ink layer 15. In this embodiment, the releasing layer 13 is formed on the dulling layer 12, and the dulling particles 121 generate a second protrusion-recession surface 131 on the releasing layer 13. As shown in FIG. 6, a stripping force separates the dulling layer 12 from the releasing layer 13, and the second protrusion-recession surface 131 is thus exposed. Then, the decorative film without the hard layer 14 also has a rugged surface with protrusions and recessions. In this embodiment, the dulling layer 12 may also have at least two different thicknesses at different regions of the same plane, as shown in FIG. 7. Thereby, the second protrusion-recession surface 131 also has different depths corresponding to the dulling layer 12. Thus, the surface of the releasing layer 13 can provide a wavelength shift of light in different directions and lead to a gradient gloss.

The low gloss surface decorative film of the present invention can integrate with various workpieces to form various decorated workpieces. The workpieces can be made of a material selected from a group consisting of polycarbonate, polypropylene, polymethylmethacrylate, MMA-St, acrylonitrile butadiene styrene, polystyrene, polyethylene terephthalate, polyoxymethylene, and a combination thereof. The decorated workpieces may be but not limited to the casings of the following products: mobile phones, digital cameras, PDA, notebook computers, desktop computers, touch screens, televisions, GPS, vehicle displays, aviation displays, digital photo frames, portable DVD players, cosmetics, toys, vehicle instrument panels, clocks, radio receivers, watches, credit cards, and smart cards.

Below are described in detail the method that modifies the proportion of the dulling particles to control the gloss of the hard layer, and the method that adjusts the thickness of the releasing layer to control the gloss of the hard layer.

### Embodiment I

In this embodiment, the gloss of the surface of the hard lard layer is modified with the proportion of the dulling particles in the dulling layer.

Firstly, 2.5%, 15% and 30% of 4 μm-diameter dulling particles are respectively added to the dulling layers. Next, the releasing layer, hard layer, ink layer and adhesion layer are sequentially coated over each dulling layer to form a multi-layer film. Next, each multi-layer film is transfer-printed onto a workpiece in an IMR process. Then, the releasing layer and dulling layer are separated from the hard layer. A photometer (NOVO-GLOSS TRIO, RHOPHOINT INSTRUMENTS) is used to detect the gloss of the hard layers from an angle of 60 degree, and the result is shown in the following table.

| | Proportion of the | |
|---|---|---|
| Particle Diameter (μm) | dulling particles (%) | 60-Degree Gloss |
| 4 μm | 2.5% | 50 |
| 4 μm | 15% | 13 |
| 4 μm | 30% | 3 |

From the table, it is known that the gloss detected at an angle of 60 degrees decreases with the increasing proportion of the dulling particles. In other words, the higher the proportion of the dulling particles, the lower the gloss of the hard layer.

### Embodiment II

In this embodiment, the gloss of the surface of the hard lard layer is modified with the thickness of the releasing layer.

Firstly, 15% of 4 μm-diameter dulling particles are added to the dulling layers. The dulling layers are coated with a thickness of 3 μm. Next, 2 μm-thick, 6 μm-thick, and 8 μm-thick releasing layers are respectively applied to the dulling layers. Next, the hard layer, ink layer, and adhesion layer are sequentially coated over each releasing layer to form a multi-layer film. Next, each multi-layer film is transfer-printed onto a workpiece in an IMR process. Then, the releasing layer and dulling layer are separated from the hard layer. A photometer (NOVO-GLOSS TRIO, RHOPHOINT INSTRUMENTS) is used to detect the gloss of the hard layers from an angle of 60 degree, and the result is shown in the following table.

| | Thickness of | |
|---|---|---|
| Particle Diameter | Releasing Layer | 60-Degree Gloss |
| 4 μm | 2 μm | 17 |
| 4 μm | 6 μm | 73 |
| 4 μm | 8 μm | 78 |
| None particle | 2 μm | 80 |

From the table, it is known that the gloss detected at an angle of 60 degrees increases with thickness of the releasing layer. In other words, the thicker the releasing layer between the dulling layer and the hard layer, the higher the gloss of the hard layer.

In conclusion, the present invention proposes a low gloss surface decorative film, wherein a dulling layer containing dulling particles is formed between the support layer and the releasing layer, and wherein the dulling particles make the dulling layer have a dulling surface with protrusions and recessions, whereby the releasing layer or the hard layer formed over the dulling surface also has protrusions and recessions correspondingly. When a stripping force separates the dulling layer and the releasing layer from the hard layer, the hard layer has a first protrusion-recession surface, which has a lower gloss and possesses an anti-fingerprint effect. Unlike the optional hard layer, the dulling layer needn't have a specified thickness in the embodiments of the present invention. Therefore, the dulling particles neither deposit nor spread unevenly even though the dulling particles have a greater diameter. Thus, the dulling particles are uniformly distributed in the dulling layer. The present invention has improvements over the conventional technologies and meets the condition for a patent. Thus, the Inventor files the application. It will be appreciated if the patent is approved fast.

The embodiments described above are only to exemplify the present invention but not to limit the scope of the present invention. Any equivalent modification or variation according to the spirit of the present invention is to be also included within the scope of the present invention.

What is claimed is:

1. A low gloss surface decorative film comprising
a dulling layer having a plurality of dulling particles secured therein, wherein said dulling particles form a dulling surface with a plurality of protrusions and recessions on one side of said dulling layer;
a hard layer formed over one side of said dulling surface and having a first protrusion-recession surface corresponding to said dulling surface; and
a releasing layer formed between said dulling layer and said hard layer, and separated from said hard layer by a stripping force,
whereby said first protrusion-recession surface of said hard layer, which faces said dulling surface, has protrusions and recessions complementary to said dulling surface.

2. The low gloss surface decorative film according to claim 1, wherein said dulling layer is partially covered by a shield layer.

3. The low gloss surface decorative film according to claim 2, wherein said hard layer has regions corresponding to said shield layer and possessing approximately planar surfaces.

4. The low gloss surface decorative film according to claim 1, wherein said dulling layer is made of a material selected from a group consisting of PU (polyurethane), PMMA (polymethylmethacrylate), epoxide, and polyester.

5. The low gloss surface decorative film according to claim 1, wherein said dulling layer has at least two different thicknesses.

6. The low gloss surface decorative film according to claim 1, wherein said dulling particles are made of a material selected from a group consisting of silicon dioxide, calcium carbonate, calcium sulfate, barium sulfate, aluminum oxide, and titanium oxide.

7. The low gloss surface decorative film according to claim 1, wherein a support layer is arranged on one surface of said dulling layer, which is opposite to said dulling surface.

8. The low gloss surface decorative film according to claim 1, wherein said hard layer is made of a material selected from a group consisting of a radiation-cured multi-functional group acrylic ester, epoxide, a vinyl ester resin, diallyo(o-)phthalate, vinyl ether, and a combination thereof.

9. The low gloss surface decorative film according to claim 1, wherein an ink layer is formed on one surface of said hard layer, which is opposite to said first protrusion-recession surface; an adhesion layer is formed on one surface of said ink layer and adheres to a workpiece.

10. A low gloss surface decorative film comprising
a dulling layer having a plurality of dulling particles secured therein, wherein said dulling particles form a dulling surface with a plurality of protrusions and recessions on one side of said dulling layer; and
a releasing layer formed on said dulling surface of said dulling layer having a second protrusion-recession surface corresponding to said dulling surface, wherein said dulling layer is separated from said releasing layer by a stripping force, whereby said second protrusion-recession surface of said releasing layer, which faces said dulling surface, has protrusions and recessions complementary to said dulling surface.

11. The low gloss surface decorative film according to claim 10, wherein said dulling layer is partially covered by a shield layer.

12. The low gloss surface decorative film according to claim 11, wherein said releasing layer has regions corresponding to said shield layer and possessing approximately planar surfaces.

13. The low gloss surface decorative film according to claim 10, wherein said dulling layer has at least two different thicknesses.

14. The low gloss surface decorative film according to claim 10, wherein said dulling particles are made of a material selected from a group consisting of silicon dioxide, calcium carbonate, calcium sulfate, barium sulfate, aluminum oxide, and titanium oxide.

15. The low gloss surface decorative film according to claim 10, wherein said dulling particles are in form of hollow spheres, non-film-forming latexes or dispersions.

16. The low gloss surface decorative film according to claim 10, wherein said dulling particles are in form of a metal powder, an organic pigment, or an inorganic pigment.

17. The low gloss surface decorative film according to claim 10, wherein a support layer is arranged on one surface of said dulling layer, which is opposite to said dulling surface.

18. The low gloss surface decorative film according to claim 10, wherein an ink layer is formed on one surface of said releasing layer, which is opposite to said second protrusion-recession surface; an adhesion layer is formed on one surface of said ink layer and adheres to a workpiece.

19. The low gloss surface decorative film according to claim 18, wherein said ink layer is made of a material selected from a group consisting of a sublime transfer-printing ink, a heat fusion transfer-printing ink, and a UV transfer-printing ink.

20. A decorated workpiece comprising
a low gloss surface decorative film according to claim 1 or claim 10; and
a workpiece decorated by said low gloss surface decorative film.

21. The decorated workpiece according to claim 20, which is a casing of a mobile phone, a digital camera, PDA, a notebook computer, a desktop computer, a touch screen, a television, GPS, a vehicle display, an aviation display, a digital photo frame, a portable DVD player, a cosmetic, a toy, a vehicle instrument panel, a clock, a radio receiver, a watch, a credit card, or a smart card.
